(19) United States
(12) Patent Application Publication
(10) Pub. No.: US 2005/0279382 A1
(43) Pub. Date: Dec. 22, 2005

(54) Method for cleaning a process chamber

(76) Inventors: Uwe Höckele, (US); Andrew Johnson, Doylestown, PA (US); Hans-Georg Kessler, Dresden (DE); Orest Nowik, (US); Kai-Alexander Schreiber, Villach (AT); Mark Ian Sistern, Crewe (GB); Hubert Winzig, Augsburg (DE)

Correspondence Address: BRINKS HOFER GILSON & LIONE, P.O. BOX 10395, CHICAGO, IL, 60610, US

(21) Appl. No.: 11/140,463

(22) Filed: May 27, 2005

Related U.S. Application Data
(63) Continuation of application No. PCT/DE03/03846, filed on Nov. 20, 2003.

(30) Foreign Application Priority Data
Nov. 30, 2002 (DE) 10255988.0

(51) Int. Cl. B08B 6/00

(52) U.S. Cl. 134/2; 134/22.1; 134/1.1

(57) ABSTRACT

A method for cleaning silicon-containing deposits in process chamber is described. Fluorine-containing compounds and additional compounds are used for the cleaning. The deposits are removed using a cleaning gas contains fluorine-containing compounds, at least 50% of which have more than one carbon atom and are C₄F₈ or C₂F₆ molecules, and additional compounds, at least 50% of which have at least one oxygen atom and at least 50% are N₂O molecules. A pressure in the chamber is between 266 Pa and 665 Pa. The method permits economical and environmentally friendly cleaning of the process chamber.

### PRIORITY

This application is a continuation of International Application PCT/DE03/03846, filed on Nov. 20, 2003, which claims the benefit of priority to German Patent Application 102 55 988.0, filed on Nov. 30, 2002, both of which incorporated herein by reference

### TECHNICAL FIELD

This invention relates to a process chamber. In particular, this invention relates to a method of operating a process chamber in which an economical and environmentally friendly cleaning mode is used.

### BACKGROUND

Process chambers are used to process semi-finished products in various ways. For example, in PECVD process chamber (plasma enhanced chemical vapor deposition), ions, radicals and excited atoms and molecules are produced from the particles of an etching gas with the aid of a plasma in order to accelerate chemical reactions leading to etching. However, the particles thus excited are scarcely oriented in comparison with a PVD process (physical vapor deposition). An SACVD (sub-atmospheric chemical vapor deposition) process chamber can also be used.

In a normal mode of operation of a process chamber, a semi-finished product is introduced into the chamber for processing. A common such process involves forming a silicon-containing layer on the semi-finished product. The semi-finished product is removed from the process chamber after production of the layer. The semi-finished product is, for example, a semiconductor wafer, in particular a silicon wafer. For example, the wafer has a diameter of 150 mm (millimeters), of 200 mm or of 300 mm.

However, silicon-containing deposits also form on chamber walls of the process chamber or on structures in the process chamber during the processing of the semi-finished products. These deposits are removed in a cleaning mode after a certain throughput of semi-finished products. In the cleaning mode, the deposits are removed using a cleaning gas mixture which, on entering the process chamber, contains fluorine-containing compounds, i.e. perfluorinated or partly fluorinated compounds, and additional compounds.

The abstract of Japanese Patent Application JP 63011674 A discloses a method for cleaning a plasma CVD chamber (chemical vapor deposition), in which a gas mixture comprising nitrogen trifluoride NF3 and argon Ar is used.

In relation to similar processes, reference is made to EP 0 464 696 A1, U.S. Pat. No. 6,068,729, U.S. Pat. No. 6,060,397, EP 1 127 957 A1, JP 09-296271 and the following article: “C₄F₈O/O₂/N-based additive gases for silicon nitride plasma enhanced chemical vapor deposition chamber cleaning with low global warming potentials”, Kim, J. H., et al., Jpn, J. Appl. Phys., Vol. 41 (2002), pages 6570-6573.

The fluorine-containing compounds are, for example, perfluorinated or partly fluorinated fluorocarbons or fluorohydrocarbons, respectively. Fluorocarbons or fluorohydrocarbons are, however, comparatively expensive process gases and environmentally polluting.

### BRIEF SUMMARY

Accordingly, a method for cleaning silicon-containing deposits in a cleaning mode of operation of a process chamber is presented. In a normal mode of operation, a silicon-containing layer is formed on a semi-finished product introduced into the process chamber and silicon-containing deposits form on chamber walls of the process chamber or on structures in the process chamber.

By way of introduction only, in one embodiment, the method comprises removing the deposits using a cleaning gas which, on entering the process chamber, contains fluorine-containing compounds and additional compounds. At least 50% of the fluorine-containing compounds are compounds which in each case contain more than one carbon atom. At least 50% of the additional compounds are compounds which in each case contain at least one oxygen atom. At least 50% of the fluorine compounds are C₄F₈ molecules. A ratio of the number of C₄F₈ molecules to the number of additional compounds in the cleaning gas is less than 1:8. A pressure in the process chamber is in the range between 266 Pa and 665 Pa. At least 50% of the additional compounds are N₂O molecules.

In another embodiment, the method comprises removing the deposits using a cleaning gas which, on entering the process chamber, contains fluorine-containing compounds and additional compounds. At least 50% of the fluorine-containing compounds are compounds which in each case contain more than one carbon atom. At least 50% of the additional compounds are compounds which in each case contain at least one oxygen atom. At least 50% of the fluorine compounds are C₂F₆ molecules. A ratio of the number of C₄F₈ molecules to the number of additional compounds in the cleaning gas is between 1:2.3 and 1:2.7. A pressure in the process chamber is in the range between 266 Pa and 665 Pa. At least 50% of the additional compounds are N₂O molecules.

The foregoing summary has been provided only by way of introduction. Nothing in this section should be taken as a limitation on the following claims, which define the scope of the invention.

### BRIEF DESCRIPTION OF THE DRAWINGS

The following text explains in more detail a number of embodiments of the invention, using schematic drawings, in which:

FIG. 1 shows a PECVD reaction chamber in one embodiment.

### DETAILED DESCRIPTION OF THE PREFERRED EMBODIMENTS

An economical and environmentally friendly cleaning method for a process chamber is described.

In various embodiments, more than fifty percent or more than ninety percent of the fluorine-containing compounds are compounds having in each case more than one carbon atom. The stated percentages are based on parts by volume in the process gas on entering the process chamber. Examples of fluorine compounds are hexafluoroethane C₂F₆, octafluoropropane C₃F₈, octafluorocyclobutane C₄F₈ and octafluorotetrahydrofuran C₄F₈O. The upper limit for the number of carbon atoms per compound is determined by the requirement that the compounds should be present in gaseous form during the cleaning. Thus, the upper limit is, for example, six, seven or eight carbon atoms. In one embodiment, the fluorine-containing compounds contain more than one fluorine atom.

More than fifty percent or more than ninety percent of the additional compounds are compounds having in each case at least one oxygen atom. Here too, the stated percentages are based on parts by volume.

This means that in particular no carbon tetrafluoride CF₄ is used. This compound is in fact chemically comparatively stable in comparison with other fluorine-carbon compounds and therefore leads to high emissions of so-called polyfluorinated compounds (PFC), i.e. compounds having more than one fluorine atom. In the method according to the invention, the gas utilization, for example for methods with octafluorocyclobutane C₄F₈, can be increased to values between eighty percent and ninety percent.

In comparison with a process with carbon tetrafluoride CF₄, it is possible to reduce the cleaning times by up to thirty percent so that downtimes of the process chamber are reduced or fewer process chambers are required for a constant production quantity. It is possible to reduce the PFC emissions by up to ninety percent so that more stringent environmental regulations can be fulfilled and so that smaller waste gas purification plants than to date are required. It may even be possible to dispense with the waste gas purification plant. It is possible to reduce the gas consumption by 85 percent by weight so that the costs decrease by up to 60 percent without the cleaning effect being adversely affected.

Moreover, the additional compounds permit optimization of the etching rate. It is true that the etching rate reaches a maximum with increasing number of carbon atoms in the fluorine compounds and with the increasing oxygen content in the cleaning gas. The etching rate considerably influences the cleaning time with constant other parameters, in particular with constant plasma power.

In a further development, the fluorine compounds are octafluorocyclobutane C₄F₈. In an alternative further development, octafluorotetrahydrofuran molecules C₄F₈O are used as fluorine compounds. The ratio of the number of fluorine compounds to the number of additional compounds in the cleaning gas is in particular less than 1:8 but greater than 1:20 in these further developments.

A further development relates to a cleaning process which is characterized by the process parameters and emissions stated in the table below:

TABLE 1
C₄F₈cleaning method

| | |
|---|---|
| PFC (sccm) | 300 |
| N₂O (sccm) | 3000 |
| Pressure (mmHg) | 2.9 |
| | (386 Pa) |
| RF power (watt) | 1000 |
| Cleaning time (s) | 76 |
| SiF₄ emission (scc) | 203 |
| CF₄ emission (scc) | 144 |
| C₂F₆ emission (scc) | 0 |
| C₄F₈ emission (scc) | 307 |
| PFC × 10⁻⁹ (MMTCE) | 7.54 |
| Gas consumption (g) | 5.4 |

The gas flow of C₄F₈ gas is 300 sccm. The gas flow of the additional gas nitrous oxide N₂O is 3000 sccm. In the further development, the ratio of the gas flow rates is 1:10.

The unit sccm means standard cubic centimeter per minute at atmospheric pressure and at standard temperature. The air pressure at sea level, i.e. a pressure of 1013.2 hPa (hectopascal), is used as atmospheric pressure. Here, a temperature of 20° C. (degrees Celsius) or of 293.15 K (degrees Kelvin) is regarded as standard temperature.

A specification in percent by volume is also possible. Thus, in the further development, ten percent by volume of octafluorocyclobutane C₄F₈ and ninety percent by volume of nitrous oxide N₂O are contained in the cleaning gas.

The pressure in the cleaning chamber is 2.9 mmHg or 386 Pa (Pascal). In order to achieve a sufficiently high etching rate, the power introduced into the process chamber during the cleaning for producing a plasma is 1000 watt. For example, a cleaning time of 76 s (seconds), i.e. a very short cleaning time, results for a silane-based silicon nitride layer SiNₓ, e.g. Si₃N₄, having a thickness of 1.46 μm (micrometers).

The emission of silicon tetrafluoride SiF₄ is a measure of the progress of the cleaning process. In a further development, 203 scc (standard cubic centimeter) of silicon tetrafluoride SiF₄ are expelled during the cleaning process, i.e. a comparatively high value. Moreover, 144 scc of carbon tetrafluoride CF₄ and 307 scc of octafluorocyclobutane C₄F₈ form. The amount of hexafluoroethane C₂F₆ produced is negligibly small.

From the emission values, it is possible to calculate a measure MMTCE (million metric tons carbon equivalent) according to the following formula:
MMTCE=sum(i, Qi(kg)·12/44 GWP100)·10⁻⁹ (1)
in which i is a consecutive variable which specifies the number of carbon atoms in the fluorine-carbon compounds emitted. Thus, Q1 relates to the mass of carbon tetrafluoride CF₄ in the waste gas, Q2 relates to the mass of hexafluoroethane C₂F₆ in the waste gas, Q3 relates to the mass of octafluoropropane C₃F₈ in the waste gas, Q4 relates to the mass of octafluorocyclobutane C₄F₈, etc. The quantity GWP100 denotes a hundred-year global warming potential of the respective fluorine compound. The fact that the global warming potential GWP100 of carbon tetrafluoride CF₄, hexafluoroethane C₂F₆ and octafluorocyclobutane C₄F₈ are 6500, 9200 and 8700, respectively, was taken from the literature.

The emitted volume of the fluorine-carbon compounds can be converted from scc into a mass using the molecular weights, CF₄ having a molecular weight of 88 amu (atomic mass unit), C₂F₆ having a molecular weight of 138 amu and C₄F₈ having a molecular weight of 200 amu. A value of 7.54×10⁻⁹ MMTCE results, i.e. a comparatively low value. The total gas consumption is 5.4 g (gram) for the entire cleaning process. This is likewise a very low value.

In a next further development, a cleaning process is carried out which is characterized by the process parameters and emissions stated in the table below:

TABLE 2
C₄F₈ cleaning method

| | |
|---|---|
| PFC (sccm) | 150 |
| N₂O (sccm) | 1800 |
| Pressure (mmHg) | 3.5 |
| | (466 Pa) |
| RF power (watt) | 1000 |
| Cleaning time (s) | 105 |
| SiF₄ emission (scc) | 210 |
| CF₄ emission (scc) | 64 |
| C₂F₆ emission (scc) | 0 |
| C₄F₈ emission (scc) | 141 |
| PFC × 10⁻⁹ (MMTCE) | 3.46 |
| Gas consumption (g) | 2.7 |

A gas flow rate of 150 sccm for octafluorocyclobutane C₄F₈ and a gas flow rate of 1800 sccm for nitrous oxide N₂O are used. This means that the ratio of the gas flow rates is 1:12.

A specification in percent by volume is also possible. Thus, in the further development, eight percent by volume of octafluorocyclobutane C₄F₈ and ninety two percent by volume of nitrous oxide N₂O are contained in the cleaning gas.

In the further development, a pressure of 3.5 mmHg, i.e. 466 Pa, prevails in the process chamber during cleaning. The power introduced for the production of the plasma during cleaning is once again 1000 watt.

A sufficiently short cleaning time of 105 s results for the abovementioned layer of silicon nitride. This time is slightly greater than the cleaning time of a cleaning process according to table 1.

The emission of silicon tetrafluoride SiF₄ is 210 scc. The emission of carbon tetrafluoride CF₄ is 64 scc. Hexafluoroethane C₂F₆ is emitted only in negligibly small amounts or is not emitted. The emission of octafluorocyclobutane C₄F₈ is 141 scc. From these values, an equivalent MMTCE of 3.46×10⁻⁹, i.e. a smaller equivalent than in the case of a process according to table 1, is calculated from these values. The gas consumption is only 2.7 g, i.e. far below the gas consumption in the case of a process according to table 1.

In another further development, the fluorine compound used is hexafluoroethane C₂F₆. The ratio of the number of fluorine compounds to the number of additional compounds is less than 1:1 but greater than 1:5.

In a next further development, the cleaning method is characterized by the process parameters and emissions stated in the table below:

TABLE 3
C₂F₆ cleaning method

| | |
|---|---|
| PFC (sccm) | 300 |
| N₂O (sccm) | 750 |
| Pressure (mmHg) | 3.5 |
| | (466 Pa) |
| RF power (watt) | 800 |
| Cleaning time (s) | 82 |
| SiF₄ emission (scc) | 203 |
| CF₄ emission (scc) | 131 |
| C₂F₆ emission (scc) | 446 |
| C₄F₈ emission (scc) | 0 |
| PFC × 10⁻⁹ (MMTCE) | 7.78 |
| Gas consumption (g) | 3.7 |

The gas flow rate for hexafluoroethane C₂F₆ is 300 sccm. The gas flow rate for nitrous oxide N₂O is 750 sccm. This gives a gas flow rate ratio of 1:2.5.

A specification in percent by volume is also possible. Thus, in the further development, twenty nine percent by volume of hexafluoroethane C₂F₆ and seventy one percent by volume of nitrous oxide N₂O are contained in the cleaning gas.

The pressure in the process chamber during the cleaning is 3.5 mmHg, i.e. 466 Pa. The power introduced for the production of plasma is 800 watt.

These process parameters result in a cleaning time of 82 s for the abovementioned layer of silicon nitride.

The emission of silicon tetrafluoride SiF₄ is 203 scc. The emission of carbon tetrafluoride CF₄ is 131 scc. The emission of hexafluoroethane C₂F₆ is 446 scc. Octafluorocyclobutane C₄F₈ is emitted only in negligibly small amounts or not emitted. An equivalent MMTCE of 7.78×10⁻⁹, i.e. once again a smaller equivalent than in the case of a process according to Table 1, is calculated according to the formula (1) from these values. The gas consumption is 3.7 g.

The values of the abovementioned tables 1 to 3 relate to a process chamber having a process space volume, as present, for example, in a plant of the type AMAT (Applied Materials) P5000 DxL (lamp heated), i.e. to a process chamber volume of 4.6 liters. The stated values are also valid for slightly larger or slightly smaller process chambers, for example for process chambers whose process space volume is up to 10 percent greater or smaller. Similarly good results to those stated above can also be achieved if the gas flow rates, pressure or the power introduced in the case of said process chamber volumes deviate slightly from the stated values, for example in a range of plus ten percent or of minus ten percent.

If a process chamber having a greatly differing process chamber geometry is used, for example a plant of the type AMAT (Applied Materials) P5000 DxZ (inductively heated) having a process chamber volume of 6.4 liters, the values stated in the tables can be converted into suitable values. The input power density of the plasma should remain the same. The gas flow rates are changed in the ratio of the process space sizes. The pressure can remain unchanged.

According to a second aspect, the invention relates generally to a method in which at least fifty percent or more than ninety percent of fluorine-containing compounds contain in each case at least one carbon atom or a plurality of carbon atoms and/or at least one oxygen atom and/or at least one nitrogen atom or at least one sulphur atom are used for the cleaning. For example, nitrosyl fluoride FNO or nitrosyl trifluoride F₃NO is used as a fluorine-containing gas together with an oxygen-containing additional gas. Alternatively or cumulatively, nitrogen trifluoride NF₃ can be used. Nitrogen fluoride NF₃ can be used. It is also possible to use sulphur tetrafluoride SF₄ or sulphur hexafluoride SF₆ as a fluorine-containing compound together with an oxygen-containing additional gas.

Accordingly, the following 18 groups of compound are affected, F denoting a fluorine atom or a plurality of fluorine atoms, C denoting a carbon atom or a plurality of carbon atoms, O denoting an oxygen atom or a plurality of oxygen atoms, N denoting a nitrogen atom or a plurality of nitrogen atoms and S denoting a sulphur atom or a plurality of sulphur atoms, and it being possible for the compounds to contain, apart from said atoms, either no further atom or one or more further atoms: F/C, F/C/O, F/C/N, F/C/S, F/C/O/N, F/C/O/S, F/C/O/N/S, F/C/N, F/C/N/S, F/C/S, F/0, F/N, F/S, F/O/N F/O/S, F/O/N/S, F/N/S and F/S.

Nitrous oxide N₂O is used in particular in plants in which strict separation of oxygen and silane SiH₄ is not ensured. In order to reduce the risk of explosion, an oxide of nitrogen is used instead of pure oxygen O₂.

In another further development, however, gaseous oxygen O₂ is used as an additional compound if the process chamber is designed for strict separation of oxygen O₂ and silane SiH₄.

If, in another further development, the silicon-containing layer is produced by a silane-based method, suitable process gases are both octafluorocyclobutane C₄F₈ and hexafluoroethane C₂F₆. If the silicon-containing layer is produced by a TEOS method (tetra ethyl ortho silicate), a suitable process gas is in particular hexafluoroethane C₂F₆, octafluoropropane C₃F₈, octafluorocyclobutane C₄F₈ or octafluorotetrahydrofuran C₄F₈O.

The method is suitable for the cleaning of a process chamber in which a silicon nitride layer Si₃N₄, an undoped silicon dioxide layer SiO₂ or a doped silicon dioxide layer SiO₂ has been deposited.

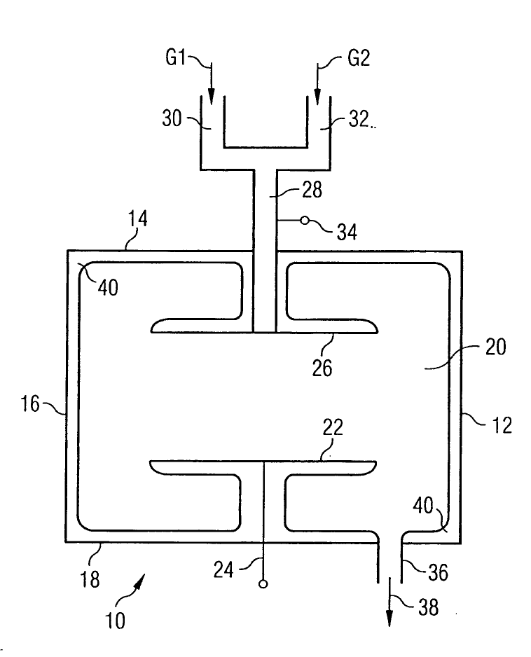

Working examples are explained below with reference to the attached drawing. FIG. 1 shows a PECVD reaction chamber 10 which contains a reaction space 20 surrounded by chamber walls 12 to 18. The reaction space 20 is, for example, cylindrical.

A wafer-holding means 22, which is simultaneously formed as an electrode and which is electrically connected to the lower electrode connection 24, is present in the reaction space 20.

Arranged above the wafer-holding means 22 is a gas inlet head 26 which contains, for example, several hundred gas inlet orifices. The gas inlet head 26 is connected to a gas inlet pipe 28. Inter alia, two gas pipes 30 and 32 lead to the gas inlet pipe 28 for admission of a process gas G1 and of a process gas G2, respectively. The gas inlet head 26 also serves as the upper electrode (cf. upper electrode connection 34).

The reaction chamber 10 also contains a gas outlet pipe 36 through which waste gases 38 are removed from the reaction space 20. The gas outlet pipe 26 leads to a pump which is not shown and which generates reduced pressure in the reaction space 20. The waste gas purification apparatuses in which, for example, a combustion or a scrubbing process takes place are located downstream of the pump.

In a normal mode of operation, for example, a thin silicon nitride layer is produced on wafers which are held on the wafer-holding apparatus 22. For example, silane SiH₄ and a nitrogen component are used here. A coating 40, which has to be removed again from time to time with the aid of a cleaning method in a cleaning mode of operation also forms on the chamber walls 12 to 18. As a result, flaking-off of parts of the coating 40 is avoided so that the defect density on the wafers is better controllable.

In three working examples, the processes above in the three tables 1 to 3 are carried out as cleaning processes in a plant of the type AMAT P5000 DxL. For example, for the cleaning process according to table 1, the process gas G1 is octafluorocyclobutane C₄F₈. The process gas G2 is nitrous oxide N₂O. The gas flow rates of 300 sccm for octafluorocyclobutane C₄F₈ and 3000 sccm for nitrous oxide N₂O given in Table 1 are set with the aid of mass flow controllers in the gas pipes 30 and 32, which controllers are not shown. The plasma is produced between the wafer-holding apparatus 22 and the gas inlet head 26 with the aid of the electrode connections 24 and 34. After ignition of the plasma, an electrical power of 1000 watt is input during cleaning. A throttle valve installed in the gas outlet pipe 36 is actuated so that a pressure of 386 Pa is generated in the reaction space 20.

By means of the plasma, the octafluorocyclobutane molecules C₄F₈ are cleaved into reactive free radicals. The free radicals react with the silicon nitride in the coating 40 to give silicon tetrafluoride SiF₄, which is sucked out of the reaction space 20 through the gas outlet pipe 36. The nitrogen atoms in the coating 40 form nitrogen N₂ or gaseous nitrogen compounds, such as nitric oxide NO, and are likewise sucked out via the gas outlet pipe 36. The oxygen of the nitrous oxide compounds N₂O reacts with the carbon of the free radicals, for example to give carbon dioxide or to give carbon monoxide. The formation of polymers which would reduce the etching rate is thus prevented.

The power input for producing the plasma is in the range between 700 of 1200 watt in all three working examples. Powers above 1200 watt require extensive cooling measures after the cleaning mode of operation. Powers below 700 watt lead to much longer cleaning times.

In another working example, the gas inlet of the gas inlet pipe 28 or the gas outlet in the gas outlet pipe 36 is in a position differing from that shown in FIG. 1.

On the basis of the specified process parameters, the temperature in the reaction space 20 achieves values between 300° C. (degrees Celsius) and 500° C., for example a value of 400° C.

It is therefore intended that the foregoing detailed description be regarded as illustrative rather than limiting, and that it be understood that it is the following claims, including all equivalents, that are intended to define the spirit and scope of this invention. Nor is anything in the foregoing description intended to disavow scope of the invention as claimed or any equivalents thereof.

1. A method for cleaning a process chamber in which, in a normal mode of operation, a silicon-containing layer is formed on a semi-finished product introduced into the process chamber and silicon-containing deposits form on chamber walls of the process chamber or on structures in the process chamber, the method comprising:
in cleaning mode of operation, removing the deposits using a cleaning gas which, on entering the process chamber, contains fluorine-containing compounds and additional compounds, at least fifty percent of the fluorine-containing compounds being compounds which in each case contain more than one carbon atom, at least fifty percent of the additional compounds being compounds which in each case contain at least one oxygen atom, and at least fifty percent of the fluorine compounds being C₄F₈ molecules,
wherein a ratio of the number of C₄F₈ molecules to the number of additional compounds in the cleaning gas is less than 1:8, a pressure in the process chamber is in the range between 266 Pa and 665 Pa, and at least fifty percent of the additional compounds are N₂O molecules.

2. The method according to claim 1, wherein the ratio is greater than 1:20.

3. The method according to claim 2, wherein at least one of the ratio is in the range between 1:8 and 1:12, or the pressure in the process chamber is in the range between 320 Pa and 440 Pa.

4. The method according to claim 2, wherein at least one of the ratio is in the range between 1:10 and 1:14 or the pressure in the process chamber is in the range between 440 Pa and 490 Pa.

5. The method according to claim 2, wherein the process chamber has a process space volume of 4.6±10% liters.

6. The method according to claim 5, wherein a plasma is produced in the process chamber in the cleaning mode of operation, a power input for producing the plasma is in the range of 800 watt to 1200 watt.

7. The method according to claim 5, wherein a gas flow rate of a gas containing the fluorine compound is in the range of 200 sccm to 400 sccm, and a gas flow rate of gas containing the additional compounds is in the range of 2800 sccm to 3200 sccm.

8. The method according to claim 5, wherein a gas flow rate of a gas containing the fluorine compounds is in the range of 100 sccm to 200 sccm and a gas flow rate of a gas containing the additional compounds is in the range of 1600 sccm to 2000 sccm.

9. The method according to claim 1, wherein the process chamber has a process space volume other than 4.6 liters and at least one of:
a) a plasma is produced in the process chamber in the cleaning mode of operation, a power input for producing the plasma is in the range of 800 watt to 1200 watt, or
b) for a chamber having a process space of 4.6 liters: a gas flow rate of a gas containing the fluorine compound is in the range of 200 sccm to 400 sccm, and a gas flow rate of gas containing the additional compounds is in the range of 2800 sccm to 3200 sccm, or the gas flow rate of the gas containing the fluorine compounds is in the range of 100 sccm to 200 sccm and the gas flow rate of the gas containing the additional compounds is in the range of 1600 sccm to 2000 sccm, and the gas flow rates are corrected using a correction factor determined by a ratio of the volume of the process space to 4.6 liters.

10. The method according to claim 1, wherein at least fifty percent of the fluorine-containing compounds contain at least one oxygen atom, at least one nitrogen atom, or at least one sulphur atom.

11. The method according to claim 1, wherein at least one of:
the silicon-containing layer is produced by a silane-based or a TEOS process,
the silicon-containing layer is doped or undoped,
at least fifty percent by mass of the silicon-containing layer contains silicon nitride or silicon dioxide, or
the semi-finished product is a substrate comprising a semiconductor material.

12. The method for cleaning a process chamber, in which, in a normal mode of operation, a silicon-containing layer is formed on a semi-finished product introduced into the process chamber and silicon-containing deposits form on chamber walls of the process chamber or on structures in the process chamber, the method comprising:
in a cleaning mode of operation, removing the deposits using a cleaning gas which, on entering the process chamber, contains fluorine-containing compounds and additional compounds, at least fifty percent of the fluorine-containing compounds being compounds which in each case contain more than one carbon atom, at least fifty percent of the additional compounds being compounds which in each case contain at least one oxygen atom, at least fifty percent of the fluorine compounds being C₂F₆ molecules,
wherein a ratio of the number of fluorine compounds to a number of additional compounds in the cleaning gas is in the range between 1:2.3 and 1:2.7, the pressure in the process chamber is in the range between 266 Pa and 665 Pa, and at least fifty percent of the additional compounds are N₂O molecules.

13. The method according to claim 12, wherein at least one of the ratio is 1:2.5 or the pressure in the process chamber is in the range between 266 Pa and 665 Pa.

14. The method according to claim 12, wherein the process chamber has a process space volume of 5.6±10% liters.

15. The method according to claim 14, wherein a plasma is produced in the process chamber in the cleaning mode of operation, a power input for producing the plasma being in the range of 600 watt to 1200 watt.

16. The method according to claim 14, wherein a gas flow rate of a gas containing the fluorine compounds is in the range of 200 sccm to 400 sccm and a gas flow rate of a gas containing the additional compounds is in the range of 600 sccm to 900 sccm.

17. The method according to claim 12, wherein the process chamber has a process space volume other than 5.6 liters and at least one of:
a) a plasma is produced in the process chamber in the cleaning mode of operation, a power input for producing the plasma is in the range of 600 watt to 1200 watt, or
b) for a chamber having a process space of 5.6 liters: a gas flow rate of a gas containing the fluorine compound is in the range of 200 sccm to 400 sccm, and a gas flow rate of gas containing the additional compounds is in the range of 600 sccm to 900 sccm, and the gas flow rates are corrected using a correction factor determined by a ratio of the volume of the process space to 5.6 liters.

18. The method according to claim 12, wherein at least fifty percent of the fluorine-containing compounds contain at least one oxygen atom, at least one nitrogen atom, or at least one sulphur atom.

19. The method according to claim 12, wherein at least one of:
the silicon-containing layer is produced by a silane-based or a TEOS process,
the silicon-containing layer is doped or undoped,
at least fifty percent by mass of the silicon-containing layer contains silicon nitride or silicon dioxide, or
the semi-finished product is a substrate comprising a semiconductor material.

20. A method for cleaning a process chamber having silicon-containing deposits in the process chamber, the method comprising:
removing the deposits using a cleaning gas which, on entering the process chamber, contains fluorine-containing compounds and additional compounds, at least fifty percent of the fluorine-containing compounds being compounds which in each case contain more than one carbon atom, at least fifty percent of the additional compounds being compounds which in each case contain at least one oxygen atom, and at least fifty percent of the fluorine compounds being CₓF_{y} molecules,
wherein y≧2x, a pressure in the process chamber is in the range between 266 Pa and 665 Pa, and at least fifty percent of the additional compounds are N₂O molecules and at least one of a ratio of the number of CₓF_{y} molecules to the number of additional compounds in the cleaning gas is less than 1:8 when y=2x or a ratio of the number of fluorine compounds to a number of additional compounds in the cleaning gas is in the range between 1:2.3 and 1:2.7 when y≠2x.
